(19) United States
(12) Patent Application Publication
(10) Pub. No.: US 2022/0289528 A1
(43) Pub. Date: Sep. 15, 2022

(54) ASSEMBLY CROSSBEAM AND METHOD FOR DRAWING IN CABLES, IN PARTICULAR TENDONS, ALONG A TOWER OF A WIND TURBINE

(71) Applicant: Wobben Properties GmbH, Aurich (DE)

(72) Inventors: Thomas COORDES, Ihlow (DE); Günter FLESSNER, Aurich (DE); Michael SZELAG, Aurich (DE)

(21) Appl. No.: 17/635,247

(22) PCT Filed: Aug. 11, 2020
(86) PCT No.: PCT/EP2020/072520

§ 371 Date: Feb. 14, 2022

(30) Foreign Application Priority Data
Aug. 15, 2019 (DE) 10 2019 122 021.1

(51) Int. Cl. B66C 19/00; F03D 13/20; E04H 12/16

(52) U.S. Cl. CPC B66C 19/00; F03D 13/20; E04H 12/16; F05B 2230/61; F03D 80/85

(57) ABSTRACT

An assembly crossbeam for placing on a tower top, in particular on a tower top of a tower of a wind turbine, and to a method for drawing in cables, in particular tendons, along a tower, in particular a tower of a wind turbine. The assembly crossbeam comprises a main support having a first and second end, and two auxiliary supports, each having a first and second end, wherein the two auxiliary supports are positioned on either side of the main support with each of their respective first ends at the centre of the main support, wherein on the main support there is a first trolley which can move along at least a first section of the main support, and wherein on said main support there is a second trolley which can move along at least a second section of the main support.

### BACKGROUND

### Technical Field

The invention concerns an assembly crossbeam for placing on a tower top, in particular on a tower top of a tower of a wind turbine, and a method for drawing in cables, in particular tendons, along a tower, in particular a tower of a wind turbine.

### Description of the Related Art

In concrete structures which are under high load, frequently tendons are used to prestress the structure. In particular, externally guided tendons are used which do not run inside concrete components, for example inside casing tubes which are concreted in place, but run adjacent or next to the concrete components. In particular in towers made of or comprising concrete, externally guided tendons are used. For example, towers may be produced from in-situ cast concrete, or assembled from precast concrete components. Tendons are often used in such concrete towers to prestress the tower in the longitudinal direction.

As well as tendons, other cables, such as for example electrical lines, must be routed or drawn along the tower, in particular in the vertical direction, for example from the tower base to the tower top. In particular in towers of wind turbines, the cables to be routed along the tower may have large cross-sections and/or high weights, so that usually a correspondingly high (and hence costly) crane is required for drawing them in.

For prestressing concrete towers, the ends of the tendons are usually fixed to the tower top and the tower foundation, normally by anchoring devices, and then provided with a corresponding prestress force. For towers with annular cross-section, often the externally guided tendons are arranged in a ring form and usually run in the interior of the tower. The tendons are then usually accessible from the interior of the tower.

Prestressed concrete towers are frequently used in wind turbines. A nacelle with an aerodynamic rotor is placed on the tower.

Prestressing the tendons at the tower base requires a corresponding working height for mounting and handling of a prestressing jack, which usually means that a corresponding depth must be taken into account in the construction of the tower foundation. This may lead to complex, costly and large foundation constructions. Prestressing the tendons at the tower top requires the installation of a prestressing jack at the tower top, and mounting and handling of the prestressing jack at a great height. This is also complex, and because the work is performed at great height, is associated with high requirements for working safety.

The German Patent and Trademark Office has researched the following prior art in the priority application for the present application: DE 10 2011 003 164 A1, US 2017/0 183 872 A1, WO 2010/ 147 459 A2, DE 10 2017 203 645 A1, DE 10 2018 105 276 A1.

### BRIEF SUMMARY

Provided is an improved assembly crossbeam for placing on a tower top, and an improved method for drawing in cables, in particular tendons, along a tower. In particular, provided is an assembly crossbeam for placing on a tower top and a method for drawing in cables, in particular tendons, along a tower, which reduce or eliminate said disadvantages. In particular, provided is an assembly crossbeam for placing on a tower top and a method for drawing in cables, in particular tendons, along a tower, which allow a cost-saving and/or simplified and/or reliable solution for prestressing tendons of a tower.

Provided is an assembly crossbeam for placing on a tower top, in particular on a tower top of a tower of a wind turbine, the assembly crossbeam comprising: a main girder having a first and a second end, two auxiliary girders, each having a first and a second end, wherein the two auxiliary girders are positioned on either side of the main girder with their respective first ends at the center of the main girder, wherein a first trolley is arranged on the main girder so as to be movable along at least a first portion of the main girder, wherein a second trolley is arranged on the main girder so as to be movable along at least a second portion of the main girder.

One or more embodiments are based, inter alia, on the finding that the provision of an assembly crossbeam which can be placed on the tower top brings various advantages, for example with respect to working safety and costs.

An assembly crossbeam described herein may be used in particular for routing or drawing cables, such as for example tendons or electrical lines, e.g., power transmission or grounding cables, along the tower. Drawing in cables along a tower may in particular mean routing such elements in the vertical direction, e.g., along the inside of the tower. Drawing in cables along a tower may furthermore mean initially raising first ends of such elements, e.g., in the tower interior, and then attaching the first ends to the tower top and the second ends of such elements to the tower base.

The assembly crossbeam described herein may in particular also be used to tension cables, in particular tendons, e.g., by means of a prestressing jack.

In towers of wind turbines in particular, cables usually have a large cross-section, and because of their length—which generally corresponds approximately to the tower height—a heavy overall weight. Usually therefore, a crane is required for drawing in such cables along a tower.

A crane which can also work at great tower heights is usually associated with high costs. The assembly crossbeam described herein may take over various tasks which would otherwise require such a crane (e.g., drawing in cables along the tower, in particular also prestressing tendons), and thus the usage period of such a crane can be significantly shortened, which may lead to substantial savings in time and/or cost.

Furthermore, with the assembly crossbeam described herein, the working level may be arranged above suspended loads (which are lashed for example to the trolleys of the assembly crossbeam), which significantly improves working safety in comparison with working with a crane, wherein suspended loads are (usually or partially) arranged above the working level.

The tendons are usually anchored at the tower base in the foundation, and usually anchored at the tower top on a tower top segment designed for this purpose. In hybrid towers in which a concrete tower part is topped by a (usually considerably shorter) steel tower part, anchoring usually takes place on a tower top segment which is arranged at the transition from the concrete tower part to the steel tower part. In the present application, the tower top therefore means in particular the upper end of a concrete tower or concrete tower part, in particular a tower top segment which is designed for the anchoring of tendons. Such a tower top segment may for example be a concrete segment or a steel segment or a hybrid segment made of different materials (in particular steel and concrete, but in some cases also CFC, GRP or similar).

Even if a steel tower part adjoins such a tower top segment, the term “tower top” in this application preferably means the tower top segment designed for the anchoring of tendons at the upper end of the concrete tower part or at the transition from the concrete tower part to the steel tower part.

Preferably a working platform, in some cases temporary, is provided at a lower end of the tower top or below the tower top. This serves in particular for carrying and protection of operating personnel. The working platform preferably comprises closable openings through which tendons and/or other elements can be guided through the working platform.

The assembly crossbeam serves in particular for placing on a tower top. This means in particular that the assembly crossbeam may be placed on an upper end of a usually annular tower wall. For this, the assembly crossbeam comprises the following elements: a main girder and two auxiliary girders. The main girder extends from a first end to a second end, wherein the main girder may preferably be placed with the first and second ends on the tower top. An auxiliary girder is arranged on either side in the middle of the main girder. The two auxiliary girders each extend from a first end, arranged centrally on the main girder, to a second end. These second ends of the two auxiliary girders are preferably also configured for placing on a tower top. The main girder and the two auxiliary girders of the assembly crossbeam, therefore, preferably have in top view a substantially cross-shaped form.

The assembly crossbeam furthermore comprises a first and a second trolley. Both trolleys are arranged on the main girder so as to be movable, wherein the first trolley is arranged so as to be movable along at least a first portion of the main girder, and the second trolley is arranged so as to be movable along at least a second portion of the main girder. The first and second portions of the main girder may be identical to one another, different from one another or overlapping.

Furthermore, preferably, the first and/or second trolley can be fixed to the main girder at different positions. Further preferably, function elements may be arranged on the trolleys. A function element may for example be a holding element, a winch, a prestressing jack, a construction cage, a lifting tool or similar.

Furthermore preferably, handles may be arranged on the assembly crossbeam, in particular on the main girder and/or the two auxiliary girders, for handling the assembly crossbeam and/or for gripping by the operating personnel.

The main girder preferably has a load-bearing capacity of at least 500 kg, preferably at least 1 tonne, preferably at least 1.5 tonnes, in particular at least 3 tonnes.

The assembly crossbeam described herein has various advantages. The construction with a main girder and two auxiliary girders, which are arranged on both sides of the main girder with their respective first ends in the center of the main girder, is a particularly stable and reliable design which allows safe working even at great height at the tower top.

By providing the two trolleys on the main girder, and by their movable arrangement on the main girder, a high degree of flexibility is created since various elements, such as tendons, tools or similar, can be positioned along the main girder by means of the two trolleys.

Thus for example one trolley may be used for raising a tendon from the tower base to the tower top by means of a lifting tool such as, e.g., a winch, and the other trolley may be used for prestressing the tendon by means of a tool such as, e.g., a prestressing jack. By the arrangement of the two trolleys, these may be operated independently of one another and in parallel to one another. Thus the assembly crossbeam offers great flexibility with simultaneously high safety for work at the tower top.

In a preferred embodiment, it is provided that the first and the second ends of the main girder and the respective second ends of the two auxiliary girders are designed to be arranged on a tower top so as to be movable, in particular movable in the circumferential direction. Here it is particularly preferred that the first and the second ends of the main girder, and/or the respective second ends of the two auxiliary girders, each have at least one sliding or rolling element which points downward in the operating state.

Designing the two ends of the main girder and the respective second ends of the two auxiliary girders such that they are arranged movably on a tower top further increases the flexibility of the assembly crossbeam. The movable arrangement on the tower top means in particular that the assembly crossbeam can move relative to the tower top. Particularly preferably, this is a rotational movement about a vertical axis in the operating state of the assembly crossbeam, which is preferably identical to a longitudinal axis of the tower. In particular in the case of a tower with annular cross-section, this is a movement of the two ends of the main girder and the respective second ends of the two auxiliary girders in the circumferential direction of the tower top. Usually, a support surface of the tower top is configured as a substantially horizontal annular surface of the annular tower wall of the tower top segment. The assembly crossbeam is preferably movable on and along this support surface. For this, the assembly crossbeam preferably has sliding or rolling elements which point downward in the operating state, in particular so that they can rest on a substantially horizontal support surface. Sliding or rolling elements may for example be configured as rollers or balls.

According to a preferred embodiment, it is provided that the respective second ends of the two auxiliary girders each have at least one outward-pointing sliding or rolling element.

Outward-pointing sliding or rolling elements at the respective second ends of the two auxiliary girders have in particular the following properties and advantages. An outward- pointing sliding or rolling element means in particular a sliding or rolling element which faces away from the respective first end of the respective auxiliary girder. In operating state of the assembly crossbeam on a tower top, such sliding or rolling elements preferably face an inner wall of the tower top and bear against this inner wall. Particularly preferably, the sliding or rolling elements are configured to bear for example on the inside of an upper flange of the tower top, the top side of which forms the support surface for the assembly crossbeam. In this way, the stability of the assembly crossbeam can be further increased. Sliding or rolling elements may for example be configured as rollers or balls.

A further preferred refinement is distinguished in that the respective first ends of the two auxiliary girders are connected movably, in particular pivotably, to the main girder.

Preferably, the respective first ends of the two auxiliary girders are connected to the main girder so as to be pivotable about a substantially vertical axis. Further preferably, the two auxiliary girders are each fixable relative to the main girder, in particular fixable in various positions.

In this way, the assembly crossbeam can be considerably reduced in its dimensions, for example in a transport state, since the two auxiliary girders can be brought closer to the main girder by pivoting. In operating state however, the auxiliary girders can preferably be swiveled out so as to give the described, preferably cross-shaped form of the assembly crossbeam in top view. It is particularly preferred, and favorable for working safety and transport safety, if the two auxiliary girders can be fixed in various positions, in particular in the operating position and a transport position, relative to the main girder, so as to prevent undesired or unintentional changing of the position of the auxiliary girders.

It is furthermore preferably provided that the first and second ends of the main girder and/or the respective second ends of the two auxiliary girders each have at least one guide face which opens at the bottom in the operating state. A guide face which opens at the bottom in the operating state here in particular means a guide face which has an upper and a lower end, wherein in the state placed on the tower top, the lower end is further away from the tower top than the upper end. Such guide faces which open at the bottom serve in particular for easier placing of the assembly crossbeam on the tower top, in particular on an annular tower wall. The guide faces which open at the bottom make it easier to position the assembly crossbeam directly on the tower top, and correct the position of the assembly crossbeam as the assembly crossbeam approaches the tower top, in particular the support surface.

In a further preferred embodiment, it is provided that the first and second ends of the main girder and/or the respective second ends of the two auxiliary girders each have at least one locking element for locking the main girder on a tower top.

Locking the main girder on the tower top has the advantage that, in particular during working and/or during lifting of the tower top, in the case where the assembly crossbeam has already been placed on the tower top segment on the ground and is brought together therewith to the tower top, this is arranged thereon on a safe and nonslip fashion. While the above-described movability of the assembly crossbeam on the tower top is preferred for allowing a high flexibility, in particular with respect to positioning of function elements arranged on the trolleys as far as possible within the overall interior of the tower top, in certain situations a safe and reliable locking of the main girder to the tower top is preferred.

Preferably, the at least one locking element is connected to the main girder via a captive fixing, for example via a sling. Further preferably, the locking element comprises a safety element which prevents unintentional release of the locking element from the locked position.

A preferred refinement is distinguished in that the respective second ends of the two auxiliary girders each have at least one guide face pointing upward in operating state.

The guide faces which point upward in the operating state, at the second ends of the two auxiliary girders, preferably serve to grip below an upper flange of the tower top, the top side of which serves as a support surface. In this way, security against lifting of the second ends of the two auxiliary girders from the tower top can be guaranteed.

In a preferred embodiment, it is provided that the respective second ends of the two auxiliary girders each have a movable, in particular pivotably arranged, support element on which preferably the guide faces which point upward in operating state and/or the outward-pointing sliding or rolling elements are arranged.

The support element is preferably fixable relative to the respective auxiliary girder via a clamping element, such as for example a turnbuckle.

The arrangement of the guide faces which point upward in operating state, and/or the outward-pointing sliding or roller elements, on a support element which is arranged so as to be movable, in particular pivotable, has the advantage of simplifying positioning of the assembly crossbeam on a tower top, in particular a tower top with an upper flange, the top side of which is formed as a support surface. During placing of the assembly crossbeam, the support elements may be swiveled into a position in which they are preferably temporarily fixed by means of the clamping element and which allows sufficient space for placing the assembly crossbeam on the tower top. After this placing, preferably the support elements can be pivoted such that the guide faces which point upward in operating state grip for example below an upper flange of the tower top, and/or the outward-pointing sliding or rolling elements come to bear on the inner wall of the tower top, in particular of an upper flange of the tower top. In this position too, the support elements can preferably be fixed temporarily, in particular via a clamping element such as for example a turnbuckle.

According to a preferred embodiment, it is provided that a distance between the first end of the main girder and the center of the main girder is variable. In a further preferred embodiment, it is provided that a distance between the second end of the main girder and the center of the main girder is variable. A further preferred refinement is distinguished in that a distance between the respective second ends of the two auxiliary girders and the center of the main girder is variable.

Furthermore, it is preferably provided that the main girder and/or the two auxiliary girders are configured as telescopic girders. According to a preferred embodiment, it is provided that the first and/or the second ends of the main girder are arranged so as to be displaceable on extension portions of the main girder and can be fixed at different positions. In a further preferred embodiment, it is provided that the second ends of the two auxiliary girders are arranged on extension portions of the auxiliary girders and can be fixed at different positions.

The embodiments and refinements cited herein are particularly preferred for making the assembly crossbeam suitable for tower tops of different diameters. In the case of tower tops of different diameters, it is advantageous if, accordingly, also the first and second ends of the main girder, provided for being placed on the tower top, and the respective second ends of the two auxiliary girders are variable in their spacing relative to one another. For this, the main girder and/or the two auxiliary girders may be configured as telescopic girders. A further possibility is to arrange the first and second ends of the main girder and/or the respective second ends of the two auxiliary girders so as to be displaceable on the main girder or the two auxiliary girders respectively. For this, the main girder and/or the two auxiliary girders preferably comprise extension portions on which the first and second ends of the main girder or the second ends of the two auxiliary girders are arranged, and along which they can be moved and fixed at different positions. In the case of a tower top of smaller diameter, thus part of the respective extension portions would protrude outward beyond the tower top, whereas in the case of a tower top of greater diameter, said ends would be arranged at the respective outer ends of the extension portions.

It is furthermore preferably provided that a holding element is arranged at each of the first and second ends of the main girder for receiving function elements. According to a preferred embodiment, it is provided that a holding element is arranged centrally on the main girder for receiving function elements. In a further preferred embodiment, it is provided that the first and/or the second trolley has holding elements for receiving function elements.

In a preferred embodiment, it is provided that the first trolley is arranged on an underside of the main girder and the second trolley is arranged on a top side of the main girder, or the first trolley and the second trolley are arranged on an underside of the main girder, or the first trolley and the second trolley are arranged on a top side of the main girder.

It is furthermore preferred that the first trolley is arranged between the first end of the main girder and a center of the main girder, and the second trolley is arranged between the second end of the main girder and the center of the main girder. A further preferred refinement is distinguished in that both trolleys are arranged between the first end of the main girder and a center of the main girder. Furthermore, it is preferably provided that the first and/or the second trolley is releasably arranged on the main girder. In a further preferred embodiment, it is provided that the first and/or the second trolley is/are positionable in at least two different positions on the main girder.

The preferred embodiment and refinements described herein with respect to the configuration of the trolleys have various advantages. Overall, a flexible arrangement of the trolleys is preferred in order to increase accordingly the flexibility of the assembly crossbeam with respect to reaching different positions within the tower top. Depending on the work to be performed and/or which working method is preferred with the two trolleys, it may be advantageous to arrange both trolleys on one half of the main girder, i.e., for example between the first end of the main girder and the center of the main girder (or accordingly, to arrange both trolleys between the second end of the main girder and the center of the main girder). It may however also be preferred to arrange the first trolley between the first end of the main girder and the center of the main girder, and the second trolley on the other half of the main girder, i.e., between the second end of the main girder and the center of the main girder. Here, it is particularly preferred that the first and/or the second trolley is arranged releasably on the main girder so that it is possible to switch between different positioning alternatives. It is also preferred that the trolleys are positionable at different positions on the main girder. It is furthermore particularly preferred that the main girder is configured so as to receive the first and/or the second trolley in at least two different positions.

A further preferred refinement is characterized by a cover.

Here it is particularly preferred that the cover has a preferably two-piece or multipiece, in particular flexible cover hood, and a cover frame which in particular is configured for fixing the cover hood.

The cover frame thus serves in particular for carrying or supporting the cover hood. Preferably, the cover, in particular the cover frame and/or the cover hood, is movable together with the assembly crossbeam on the tower top. This has the advantage that for example a rotation of the assembly crossbeam about a vertical axis leads to a co-rotation of the cover.

According to a preferred embodiment, it is provided that the cover frame has a preferably at least two-piece, at least three-piece, at least four-piece or multipiece cover ring. Furthermore, it is preferably provided that the cover frame has a central clamping mandrel, preferably with a clamping plate. A further preferred refinement is distinguished in that the cover frame has two clamping brackets, which each extend preferably over at least a portion of the main girder starting from its first or second end respectively. The provision of two clamping brackets which extend over portions of the main girder has the advantage that a region above the main girder is kept clear, so as not to block the movability of the first and/or second trolley along the main girder by the cover hood.

According to a preferred embodiment, it is provided that the cover hood has several closable openings. A further preferred refinement is distinguished in that the cover hood comprises fixing elements.

Closable openings of the cover hood facilitate access and/or the passage of elements through the cover hood. Fixing elements of the cover hood may be openings in the cover hood in which complementary fixing elements engage, by means of which the cover hood can be attached preferably releasably to the cover frame.

Further advantageous embodiment variants of the above-described device arise from combination of the preferred features presented herein.

According to a further aspect of the invention, the object cited initially is achieved by a method for drawing in cables, in particular tendons, along a tower, in particular a tower of a wind turbine, the method comprising: placing an above-described assembly crossbeam on a tower top of the tower, arranging a lifting tool on the first and/or second trolley, pulling a first end of the cables up to the tower top by means of the assembly crossbeam.

A preferred refinement of the method is characterized by positioning the assembly crossbeam at a desired circumferential position, and/or locking the assembly crossbeam, and/or arranging and/or fixing a second end of the tendon to the tower base, and/or arranging a prestressing jack on the first and/or second trolley, prestressing a tendon by means of the prestressing jack, and/or fixing the first end of the cables, in particular the tendon, to the tower top.

The order of the method steps described herein is preferred but may also be different.

The method described above and its possible refinements preferably comprise features or method steps which make them particularly suitable for use with an assembly crossbeam according to the invention and its refinements.

For the advantages, embodiment variants and embodiment details of this further aspect of the invention and its refinements, reference is made to the preceding description of the corresponding device features.

### BRIEF DESCRIPTION OF THE SEVERAL VIEWS OF THE DRAWINGS

Preferred exemplary embodiments are described as an example with reference to the appended figures. The drawings show:

FIG. 1 shows a schematic illustration of a wind turbine;

FIG. 2 shows a three-dimensional illustration of an exemplary embodiment of an assembly crossbeam;

FIG. 3 shows a further three-dimensional illustration of the assembly crossbeam from FIG. 2;

FIG. 4 shows a schematic illustration of an extract of an exemplary embodiment of an assembly crossbeam placed on a tower top;

FIG. 5 shows a schematic, three-dimensional illustration of an embodiment of an assembly crossbeam placed on a tower top;

FIG. 6 shows a top view of the assembly crossbeam from FIG. 2;

FIG. 7 shows a side view of the assembly crossbeam from FIG. 2;

FIG. 8 shows a further side view of the assembly crossbeam from FIG. 2;

FIG. 9 shows a three-dimensional view of an exemplary embodiment of a cover frame;

FIG. 10 shows a top view of the cover frame from FIG. 9;

FIG. 11 shows a side view of the cover frame from FIG. 9 with an enlarged detail Z;

FIG. 12 shows a further side view of the cover frame from FIG. 9;

FIG. 13 shows a three-dimensional illustration of an exemplary embodiment of a cover frame with holding bracket;

FIG. 14 shows a three-dimensional illustration of an exemplary embodiment of an assembly crossbeam with cover frame and cover hood;

FIG. 15 shows a schematic illustration of an exemplary embodiment of a method for prestressing tendons of a tower;

FIG. 16 shows a longitudinal section of an upper end of a tower with an exemplary embodiment of an assembly crossbeam;

FIG. 17 shows a sectional view through an exemplary embodiment of an assembly crossbeam;

FIG. 18 shows the second end of an auxiliary girder of an exemplary embodiment of an assembly crossbeam with support element in closed position; and

FIG. 19 shows the second end of an auxiliary girder of an exemplary embodiment of an assembly crossbeam with support element in open position.

In the figures, the same elements or those with substantially equivalent function carry the same reference signs. General descriptions usually relate to all embodiments unless differences are explicitly indicated.

### DETAILED DESCRIPTION

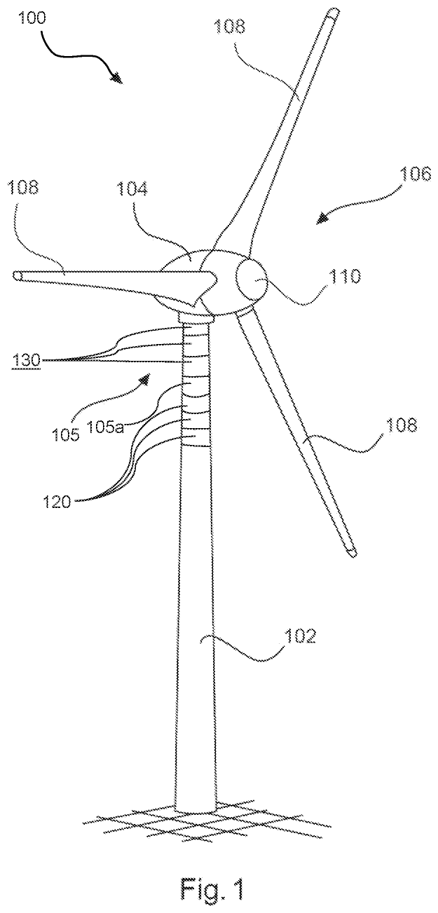

FIG. 1 shows a schematic illustration of a wind turbine according to the invention. The wind turbine 100 has a tower 102 and a nacelle 104 on the tower 102. An aerodynamic rotor 106 with three rotor blades 108 and a spinner 110 is provided on the nacelle 104. The aerodynamic rotor 106 is set in a rotational movement by the wind during operation of the wind turbine and thus also turns an electrodynamic rotor of a generator which is directly or indirectly coupled to the aerodynamic rotor 106. The electric generator is arranged in the nacelle 104 and generates electrical energy. The pitch angle of the rotor blades 108 may be changed by pitch motors at the rotor blade roots of the respective rotor blades 108.

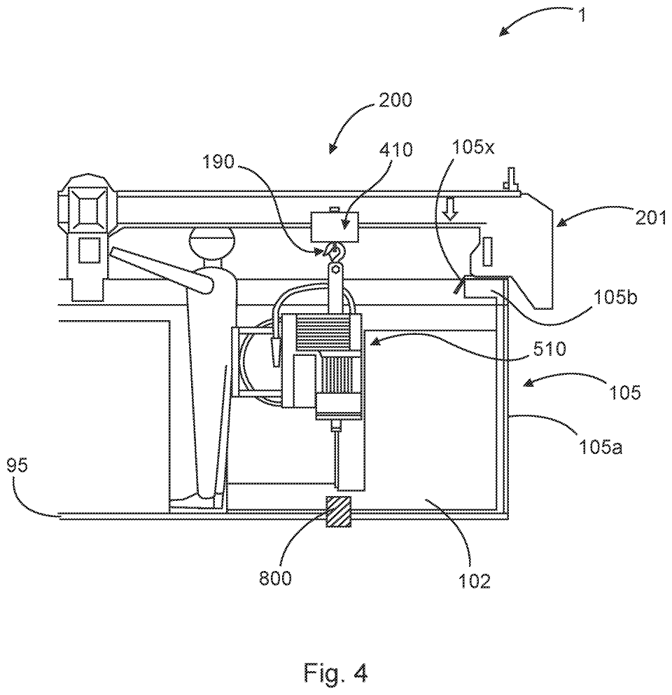

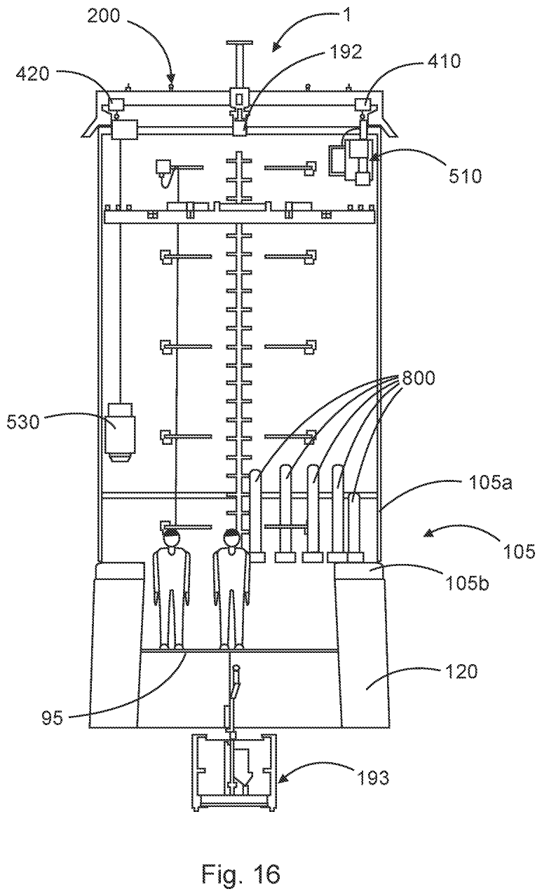

The tower 102 is configured as a hybrid tower with a concrete tower part with concrete segments 120, and a steel tower part with steel segments 130. The tower top 105 here designates the upper end of the concrete tower part with concrete segments 120, in particular the tower top segment 105a at the transition from the concrete tower part to the steel tower part, which segment is configured for anchoring of tendons 800 (see FIG. 4 and FIG. 16). The tower top 105 here in particular is the upper end of a concrete tower 102 or a concrete tower part with concrete segments 120, in particular a tower top segment 105 which is configured for anchoring of tendons 800. Although a steel tower part with steel tower segments 120 adjoins such a tower top segment 105a, the tower top 105 in this application preferably designates the tower top segment 105a configured for anchoring of tendons at the upper end of the concrete tower part or at the transition from the concrete tower part to the steel tower part.

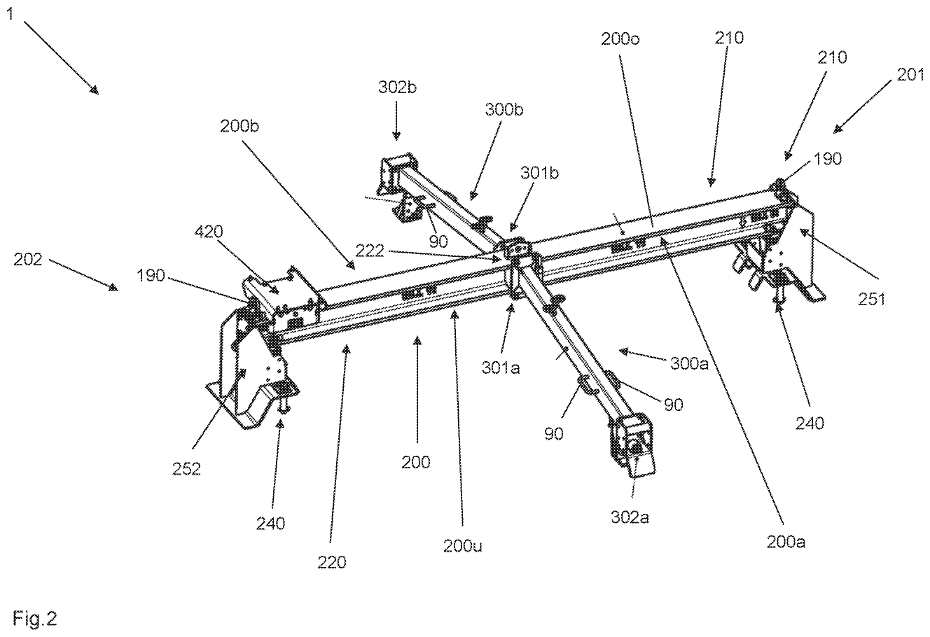

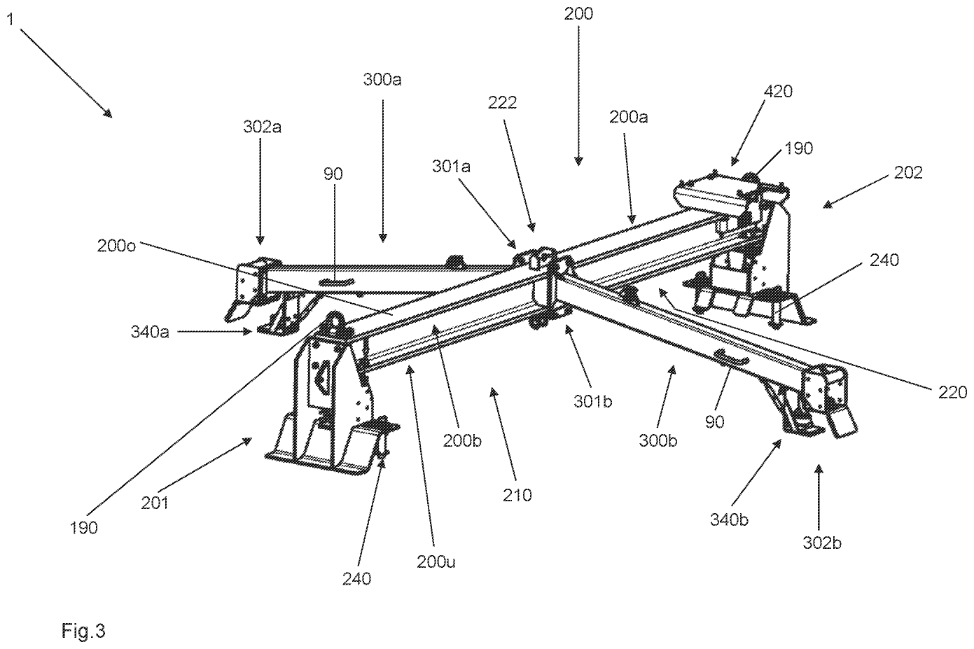

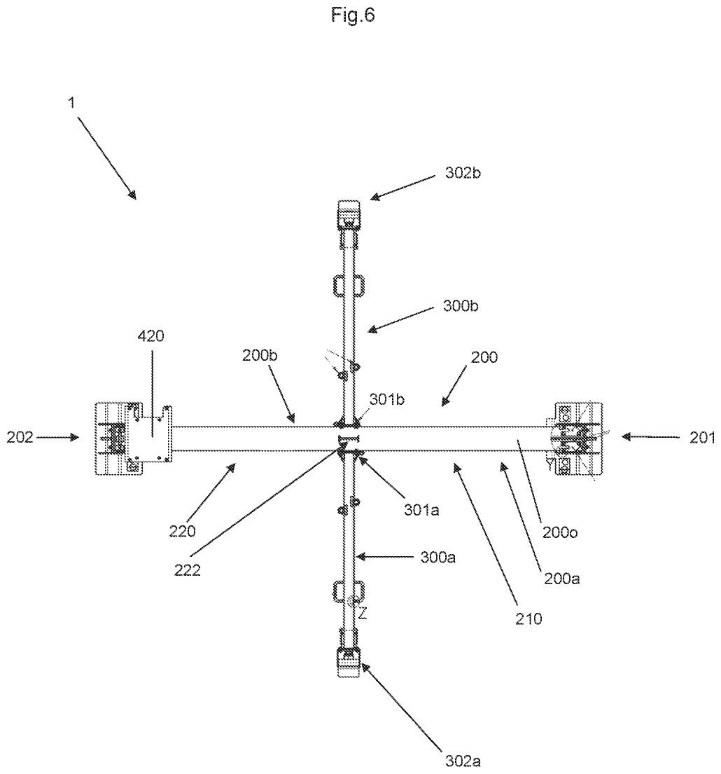

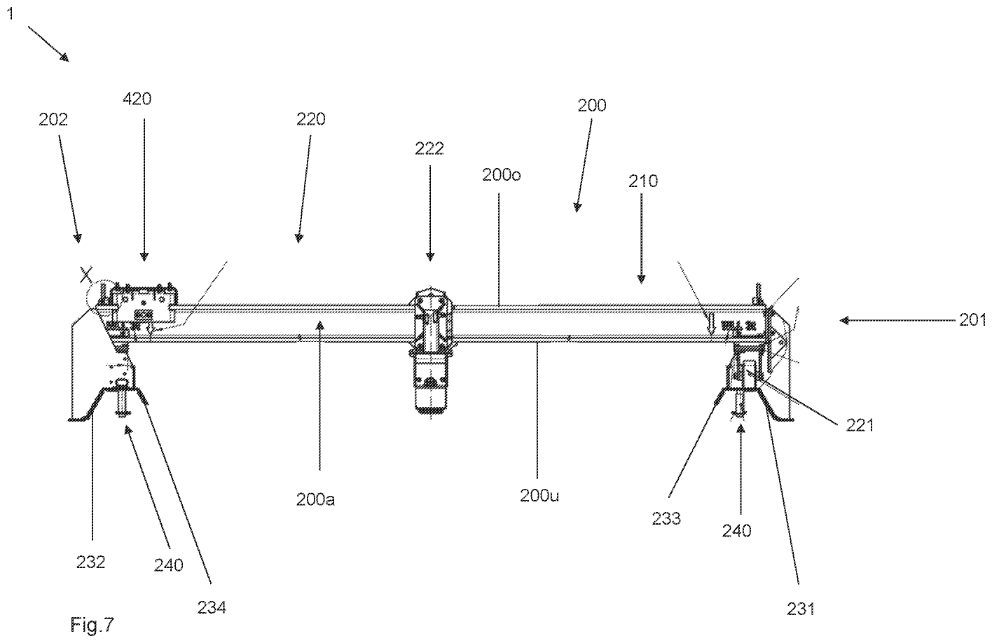

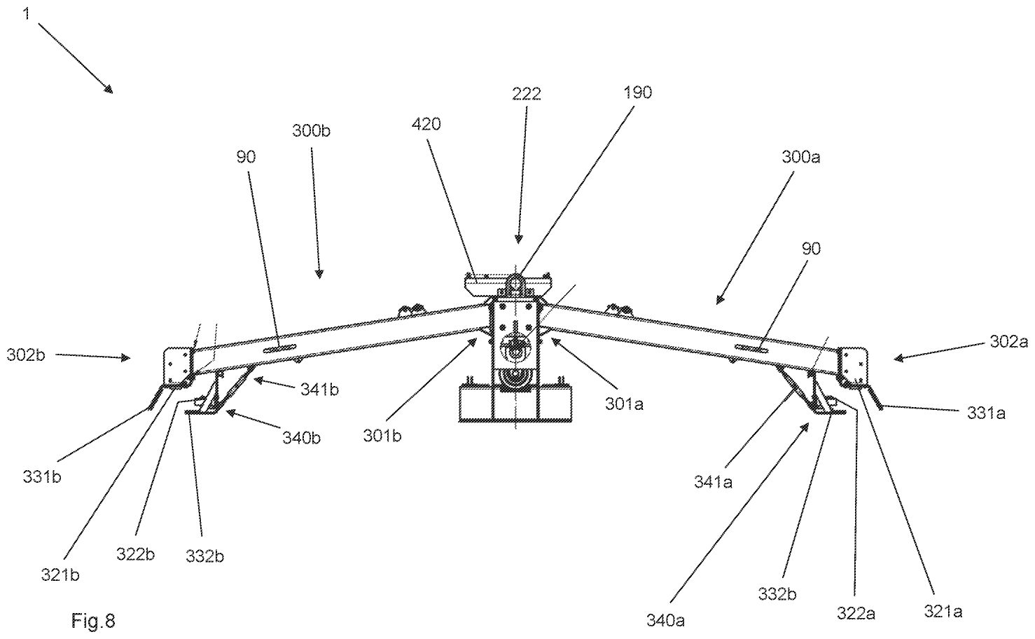

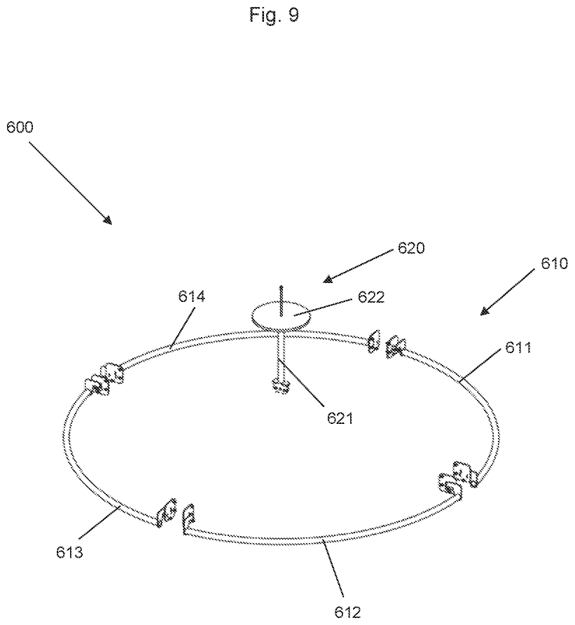

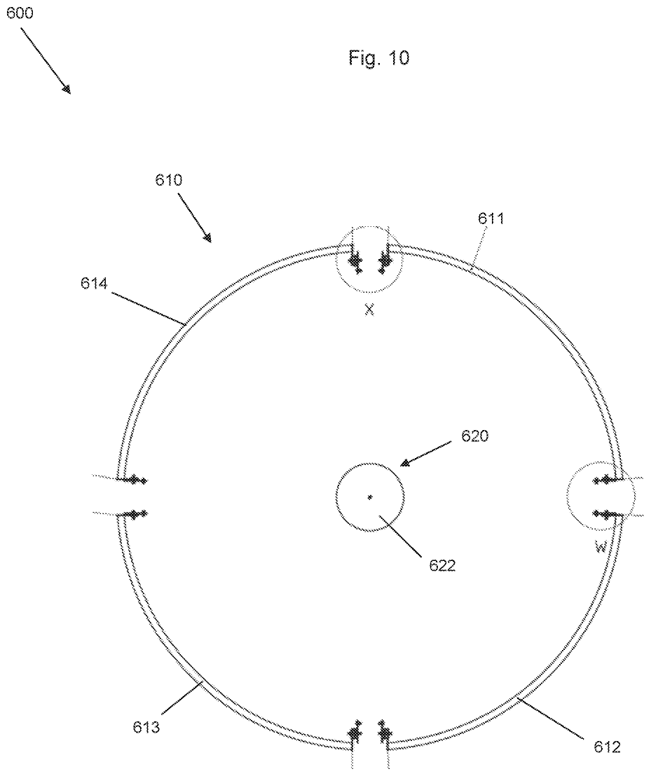

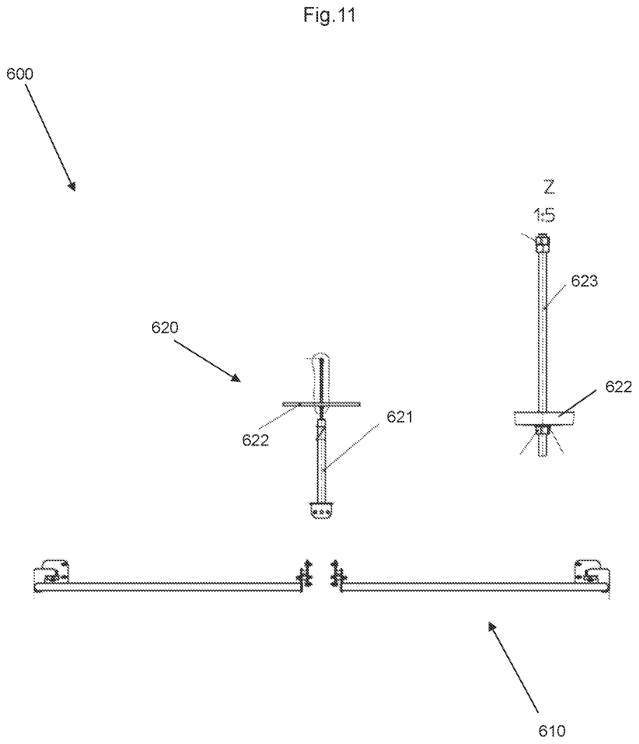

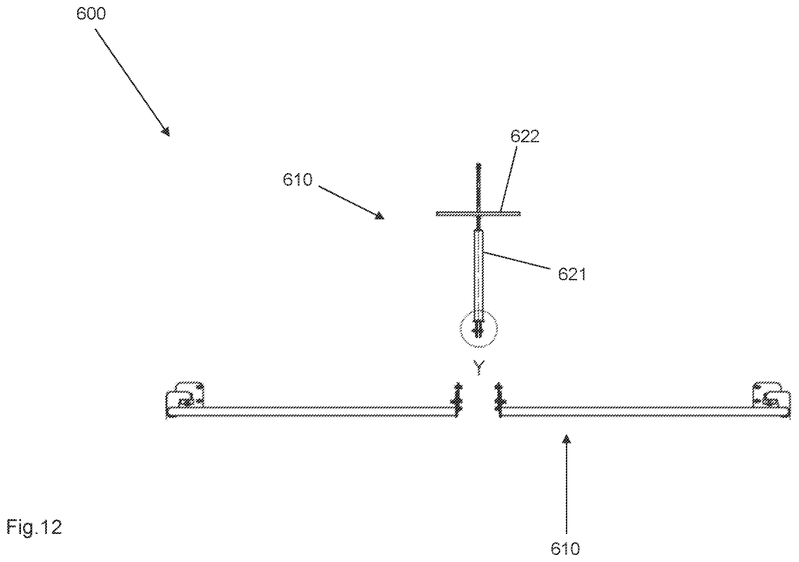

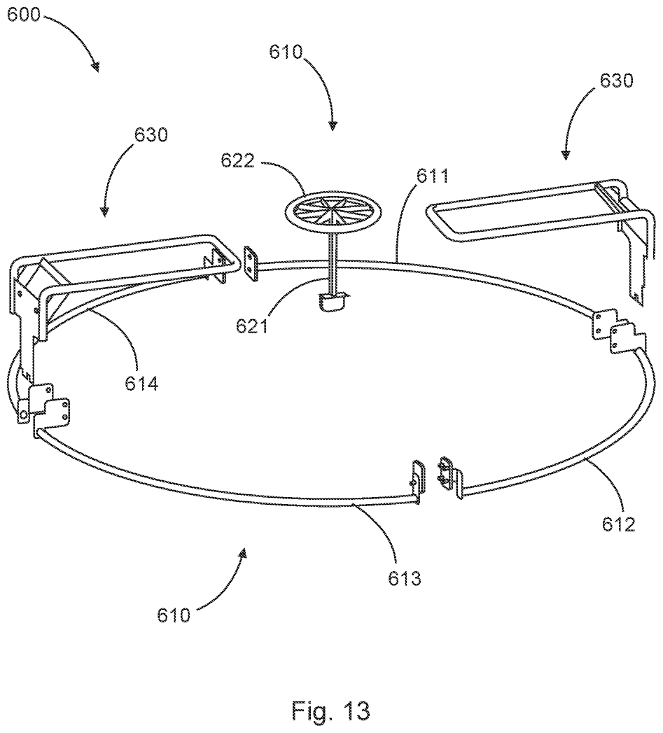

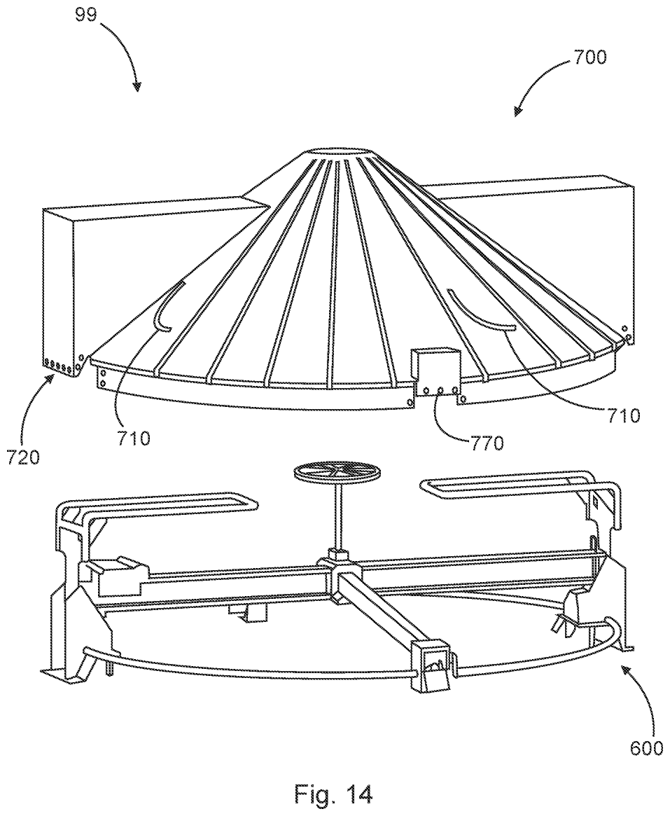

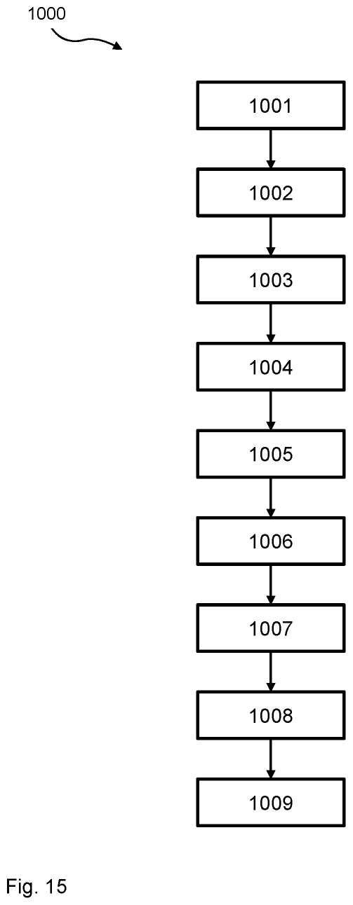

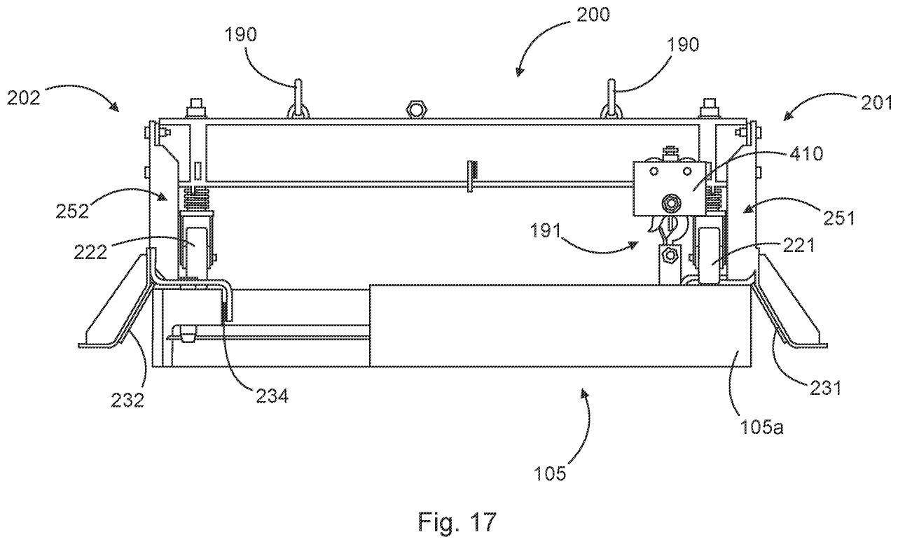

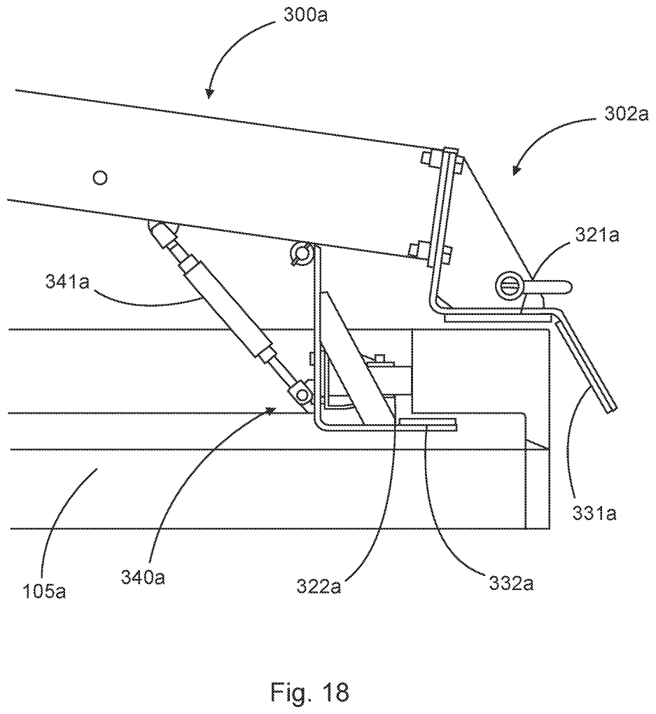

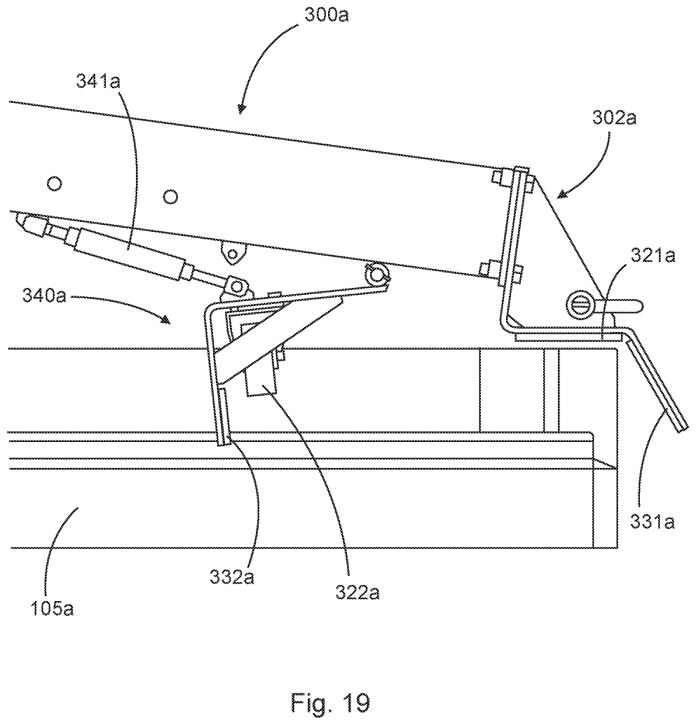

FIGS. 2-8 illustrate exemplary embodiments of an assembly crossbeam 1. FIGS. 9-13 illustrate exemplary embodiments of a cover frame 600; FIG. 14 shows an assembly crossbeam 1 with cover frame 600 and cover hood 700. FIG. 15 shows a schematic illustration of an exemplary embodiment of a method 1000 for prestressing tendons 800 of a tower 102. The figure shows a longitudinal section of an upper end of a tower with an exemplary embodiment of an assembly crossbeam 1, and FIG. 17 shows a sectional view through an exemplary embodiment of an assembly crossbeam. FIGS. 18 and 19 finally show the second end 302a of an auxiliary girder 300a of an exemplary embodiment of an assembly crossbeam with the support element 340 in the closed and open positions respectively.

An assembly crossbeam 1 serves in particular for placing on a tower top 105 of a tower 102 of a wind turbine 100. By means of the assembly crossbeam 1 and function elements arranged thereon, in particular externally guided tendons 800 may be prestressed at the tower top 105.

The assembly crossbeam 1 comprises a main girder 200 with a first end and a second end 201, 202. Furthermore, the assembly crossbeam 1 comprises two auxiliary girders 300a, 300b, each with a first end and a second end 301a, 301b; 302a, 302b. The two auxiliary girders 300a, 300b are arranged on either side 200a, 200b of the main girder 200 with their respective first ends 301a, 301b each in the center of the main girder 200.

The first and second ends 201, 202 of the main girder 200 comprise at least one locking element 240 for locking the main girder 200 to a tower top 105. The locking elements 240 are preferably connected to the main girder 200 via a captive fixing, e.g., via a sling. Further preferably, the locking element comprises a safety element which prevents unintentional release of the locking element from the locked position.

The first and second ends 201, 202 of the main girder 200 furthermore each comprise a side part 251, 252 (see FIGS. 2 and 17). The height of the side parts 251, 252 is preferably matched to a necessary working height below the assembly crossbeam 1, for example between a working platform and the assembly crossbeam 1. Further preferably, the side parts 251, 252 may be releasable and/or interchangeable, and/or configured as telescopic elements so that the height of the side parts 251, 252 and hence the working height below the assembly crossbeam 1 can be changed.

On an underside 200u of the main girder 200, a first trolley 410 is arranged so as to be movable along at least a first portion 210 of the main girder 200 (see for example FIG. 4). On a top side 200o of the main girder 200, a second trolley 420 is arranged so as to be movable along at least a second portion 220 of the main girder 200. In the embodiment shown in FIG. 16, the second trolley 420 is also arranged on the underside of the main girder 200.

The first trolley 410 is arranged between the first end 201 of the main girder 200 and a center 222 of the main girder 200, and the second trolley 420 is arranged between the second end 202 of the main girder 200 and the center 222 of the main girder 200. Preferably, the first and second trolleys 410, 420 are releasably arranged on the main girder 200 and can be positioned in at least two different positions on the main girder 200.

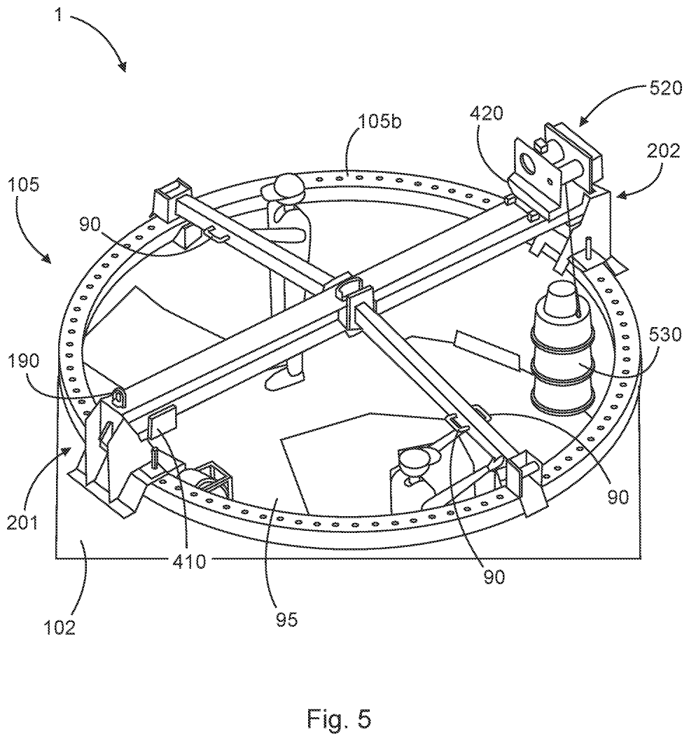

Various function elements may be arranged on the trolleys 410, 420. The first and/or the second trolley 410, 420 preferably comprises holding elements 191 for receiving function elements. For example, in FIG. 4 a first winch 510 is arranged on the first trolley 410, and in FIG. 5 a second winch 520 and a prestressing jack 530 are arranged on the second trolley 420.

FIGS. 4 and 5 show the assembly crossbeam 1 in operating state in which the assembly crossbeam 1 is placed on the tower top 105. The tower top segment 105a has an upper flange 105b which on its top side has a substantially horizontal support surface for the assembly crossbeam 1.

The upper flange 105b of the tower top segment 105a furthermore comprises several passage openings which in particular serve to receive fixing elements, by means of which a steel segment 130 can be attached to the tower top segment 105a. In the operating state of the assembly crossbeam 1 shown in FIGS. 4 and 5, preferably the locking elements 240 of the main girder 200 may be attached in the openings of the upper flange 105b of the tower top segment 105a.

FIG. 5 furthermore shows a working platform 95 on which two operating personnel are standing. The working platform 95 preferably comprises closable openings through which, e.g., tendons, cables or similar may be passed. FIG. 4 furthermore shows the upper end of a tendon 800. Handles 90 are arranged on the auxiliary girders 300a, 300b.

The first and second ends 201, 202 of the main girder 200, and the respective second ends 302a, 302b of the two auxiliary girders 300a, 300b are configured so as to be arranged movably, in particular movably in the circumferential direction, on the tower top 105. The first and second ends 201, 202 of the main girder 200, and the respective second ends 302a, 302b of the two auxiliary girders 300a, 300b each comprise at least one sliding or rolling element 221, 321a, 321b which point downward in operating state and are here configured as rollers. The downward-pointing sliding or rolling elements 221, 321a, 321b, in the operating state of the assembly crossbeam 1, lie on the support surface of the upper flange 105b of the tower top segment 105a.

Furthermore, the respective second ends 302a, 302b of the two auxiliary girders 300a, 300b each have at least one outward-pointing sliding or rolling element 322a, 322b, here configured as rollers. The outward-pointing sliding or rolling elements 322a, 322b, in the operating state of the assembly crossbeam 1, lie on a contact face 105x of the upper flange 105b of the tower top segment 105a which faces the tower interior.

The first and second ends 201, 202 of the main girder 200 each comprise guide faces 231, 232, 233, 234 which open at the bottom in operating state. The respective second ends 302a, 302b of the two auxiliary girders 300a, 300b each comprise at least one guide face 331a, 331b which opens at the bottom in operating state. The respective second ends 302a, 302b of the two auxiliary girders 300a, 300b each have at least one guide face 332a, 332b which points upward in operating state.

The respective second ends 302a, 302b of the two auxiliary girders 300a, 300b each have a support element 340a, 340b which is arranged so as to be movable, in particular pivotable. Preferably, the guide faces 332a, 332b which point upward in operating state, and the outward-pointing sliding or rolling elements 322a, 322b, are arranged on the support element 340a, 340b. The support element 340a, 340b can preferably be fixed relative to the respective auxiliary girder via a clamping element 341a, 341b, such as for example a turnbuckle. The support elements 340a, 340b can be pivoted from an open position (see FIG. 19) into a closed position (see FIG. 18) and back.

The respective first ends 301a, 301b of the two auxiliary girders 300a, 300b are movably, in particular pivotably connected to the main girder 200.

A holding element 190 is arranged preferably at each of the first and second ends 201, 202 of the main girder 200 for receiving function elements, in particular a lifting tool, which may be used for transporting and positioning the assembly crossbeam 1.

Preferably, a holding element 192 is arranged centrally on the main girder 200 for receiving function elements. A construction cage 193 can preferably be lowered into the tower interior from here.

The assembly crossbeam 1 preferably has a cover 99 which is movable together with the assembly crossbeam 1. The cover 99 has a preferably two-piece or multipiece, in particular flexible cover hood 700, and a cover frame 600 which is in particular configured for fixing the cover hood 700.

The cover frame 600 has a cover ring 610 which, in the example shown here, comprises four part rings 611, 612, 613, 614. Furthermore, the cover frame 600 has a central clamping mandrel 610 with a clamping plate 622, wherein the clamping plate is arranged between a lower clamping mandrel portion 621 and an upper clamping mandrel portion 623.

The cover frame 600 furthermore comprises two clamping brackets 630, each of which extends preferably over at least one portion of the main girder 200 starting from its first or second end respectively. This keeps the travel path of the trolleys 410, 420 clear in that the cover hood 700 is accordingly supported by the clamping brackets above the main girder 200.

The cover hood 700 furthermore preferably comprises several closable openings 710, for example in the form of zip closures. Furthermore, the fixing elements 720 are formed on the cover hood 700 in the form of openings in which complementary fixing elements may engage, by means of which the cover hood 700 may be attached to the cover frame 600.

An exemplary method 1000 for drawing in cables, in particular tendons 800, along a tower 102 of a wind turbine, may proceed for example as described below. The order of the method steps described herein is preferred but may also be different.

Firstly, an assembly crossbeam 1 is placed 1001 on a tower top 105 of the tower 102. Then the assembly crossbeam 1 is positioned 1002 at a desired circumferential position. This is shown for example in FIG. 5, where two operating personnel grip the auxiliary girders 300a, 300b at the handles 90 and turn the assembly crossbeam 1. The movement of the assembly crossbeam in the circumferential direction may also take place or be supported via a preferably electric drive.

When the desired circumferential position is reached, the assembly crossbeam 1 is locked 1003, in particular by means of the locking elements 240 in the openings of the upper flange 105b of the tower top segment 105a.

Then a lifting tool, for example a winch, is arranged 1004 on the first and/or second trolley 410, 420, followed by pulling 1005 of a first end of the cables, in particular the tendon 800, up to the tower top 105 by means of the assembly crossbeam 1, in particular by means of a lifting tool arranged on one of the trolleys, for example in the form of a winch. A second end of the cables, in particular a tendon 800, is then arranged and/or fixed 1006 to the tower base.

After a prestressing jack 530 has been arranged 1007 at the first and/or second trolley 410, 420, in particular in the case of tendons 800, the tendon 800 is prestressed 1008 by means of the prestressing jack 530. Finally, the first end of the cables, in particular the tendon 800, is fixed 1009 to the tower top 105.

In particular, steps 1002, 1003, and 1006, 1008 and 1009 preferably take place as often as necessary for prestressing all tendons 800 of a tower 102.

1. An assembly crossbeam for placing on a tower top of a tower of a wind turbine, the assembly crossbeam comprising:
a main girder having a first end and a second end,
first and second auxiliary girders, each having a first end and a second end, wherein the first and second auxiliary girders are positioned on opposing sides of the main girder with their respective first ends at a center portion of the main girder,
wherein a first trolley is arranged on the main girder and configured to be movable along at least a first portion of the main girder,
wherein a second trolley is arranged on the main girder and configured to be movable along at least a second portion of the main girder.

2. The assembly crossbeam as claimed in claim 1, wherein the first and the second ends of the main girder and the respective second ends of the first and second auxiliary girders are designed to be arranged on the tower top so as to be movable.

3. The assembly crossbeam as claimed in claim 1, wherein:
the first and the second ends of the main girder and/or the respective second ends of the first and second auxiliary girders each have at least one sliding or rolling element that face downward in an operating state, and/or
wherein the respective second ends of the first and second auxiliary girders each have at least one outward-pointing sliding or rolling element.

4. The assembly crossbeam as claimed in claim 1, wherein the respective first ends of the first and second auxiliary girders are movably connected to the main girder.

5. The assembly crossbeam as claimed in claim 1, wherein:
the first and second ends of the main girder and/or the respective second ends of the first and second auxiliary girders each have at least one guide face that opens at a bottom in the operating state, and/or
the respective second ends of the first and second auxiliary girders each have at least one guide face that faces upward in the operating state.

6. The assembly crossbeam as claimed in claim 1, wherein the first and second ends of the main girder and/or the respective second ends of the first and second auxiliary girders each have at least one locking element for locking the main girder on the tower top.

7. The assembly crossbeam as claimed in claim 1, wherein the respective second ends of the first and second auxiliary girders each have a pivotably arranged support element on which the guide faces point upward in an operating state and/or the outward-pointing sliding or rolling elements are arranged.

8. The assembly crossbeam as claimed in claim 1, wherein:
a distance between the first end of the main girder and the center of the main girder is variable, and/or
a distance between the second end of the main girder and the center of the main girder is variable, and/or
a distance between the respective second ends of the two first and second auxiliary girders and the center of the main girder is variable.

9. The assembly crossbeam as claimed in claim 1, wherein:
the main girder and/or the first and second auxiliary girders are configured as telescopic girders, and/or
the first ends and/or the second ends of the main girder are arranged so as to be displaceable on extension portions of the main girder and are configured to be fixed at different positions, and/or
the second ends of the first and second auxiliary girders are arranged on extension portions of the auxiliary girders and can configured to be fixed at different positions.

10. The assembly crossbeam as claimed in claim 1, wherein:
a holding element is arranged at each of the first and second ends of the main girder for receiving function elements, and/or
a holding element is arranged centrally on the main girder for receiving function elements, and/or
the first trolley and/or the second trolley has holding elements for receiving function elements.

11. The assembly crossbeam as claimed in claim 1, wherein:
the first trolley is arranged on an underside of the main girder and the second trolley is arranged on a top side of the main girder, or the first trolley and the second trolley are arranged on an underside of the main girder, or the first trolley and the second trolley are arranged on the top side of the main girder; and/or
the first trolley is arranged between the first end of the main girder and a center portion of the main girder, and the second trolley is arranged between the second end of the main girder and the center of the main girder; and/or
the first and second trolleys are arranged between the first end of the main girder and the center portion of the main girder; and/or
the first trolley and/or the second trolley is releasably arranged on the main girder, and/or
the first trolley and/or the second trolley is positionable to at least two different positions on the main girder.

12. The assembly crossbeam as claimed in claim 1, comprising a cover, wherein the cover includes a flexible cover hood and a cover frame configured to fix to the cover hood.

13. The assembly crossbeam as claimed in claim 12, wherein:
the cover frame includes a four-piece cover ring, and/or
the cover frame has a central clamping mandrel, and/or
the cover frame has two clamping brackets, each extending over at least a portion of the main girder starting from first or second ends respectively.

14. A method for drawing in a cable along a tower of a wind turbine, the method comprising:
placing the assembly crossbeam as claimed in claim 1, on a tower top the tower,
arranging a lifting tool on the first trolley and/or the second trolley,
pulling a first end of the cable up to the tower top by the assembly crossbeam.

15. The method as claimed in claim 14, wherein the cable is a tendon, the method comprising:
positioning the assembly crossbeam at a predetermined circumferential position, and/or
locking the assembly crossbeam, and/or
arranging and/or fixing a second end of the tendon to the tower base, and/or
arranging a prestressing jack on the first and/or second trolley, and/or
prestressing the tendon by the prestressing jack, and/or
fixing the first end of the tendon to the tower top.

16. The assembly crossbeam as claimed in claim 2, wherein the first and the second ends of the main girder and the respective second ends of the first and second auxiliary girders are movable in a circumferential direction.
